(19) United States
(12) Patent Application Publication
(10) Pub. No.: US 2021/0130222 A1
(43) Pub. Date: May 6, 2021

(54) NEAR INFRARED ABSORPTION FILTER GLASS WITH HIGH REFRACTIVE INDEX

(71) Applicant: SCHOTT Glass Technologies (Suzhou) Co. Ltd., Jiangsu (CN)

(72) Inventors: Yigang Li, Shanghai (CN); Huiyan Fan, Jiangsu (CN); Ralf Biertümpfel, Mainz-Kastel (DE); Simone Monika Ritter, Mainz (DE)

(73) Assignee: SCHOTT Glass Technologies (Suzhou) Co. Ltd., Jiangsu (CN)

(21) Appl. No.: 17/142,847

(22) Filed: Jan. 6, 2021

Related U.S. Application Data
(63) Continuation of application No. PCT/CN2018/094922, filed on Jul. 6, 2018.

(51) Int. Cl. C03C 3/068; G02B 5/20; C03C 4/08; C03C 3/066

(52) U.S. Cl. CPC C03C 3/068; G02B 5/208; C03C 2203/10; C03C 3/066; C03C 4/08

(57) ABSTRACT

A CuO-containing glass has a refractive index n of at least 1.7, a minimum absorption coefficient in a visible wavelength range from 380 nm to 780 nm is located between 450 nm and 550 nm, a difference of the absorption coefficient normalized to CuO weight percent at a wavelength of 700 nm and the minimum absorption coefficient normalized to CuO weight percent in the visible wavelength range from 380 nm to 780 nm is at least 10/cm. The glass includes the following components (in % by weight based on oxide): 0-70 wt-% La₂O₃, 0-70 wt-% Y₂O₃; 20-70 wt-% a sum of La₂O₃+Y₂O₃+RE₂O₃; 10-40 wt-% B₂O₃; 0-40 wt-% SiO₂; 0-10 wt-% Nb₂O₅; 0-30 wt-% ZnO; 0-20 wt-% ZrO₂; 0-20 wt-% Ta₂O₅and 0.1-10 wt-% CuO. RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.

### CROSS REFERENCE TO RELATED APPLICATIONS

This is a continuation of PCT application No. PCT/CN2018/094922, entitled “NEAR INFRARED ABSORPTION FILTER GLASS WITH HIGH REFRACTIVE INDEX”, filed Jul. 6, 2018, which is incorporated herein by reference.

### BACKGROUND OF THE INVENTION

### 1. Field of the Invention

The present invention relates to a near infrared absorption filter glass with high refractive index. The invention also relates to a method of producing the glass and to uses of the glass. The glass may be used in light sensors, in particular in ambient light sensors, in the field of consumer electronics devices such as mobile phones.

### 2. Description of the Related Art

An ambient light sensor can have an optical structure combining common blue glass and transparent high refractive index optical glass together. If there is a blue glass having high refractive index, this structure could be re-designed based on this new glass material, making the related manufacture process easier. However, a suitable blue glass, in particular near infrared absorption filter glass, is not available so far because the current blue glasses do not have a high refractive index.

Current copper(II) oxide containing near infrared absorption filter glasses are based on a phosphate or fluorophosphate matrix and therefore do not generally have a high refractive index.

US 2016/0363703 A1 describes a near infrared cutoff filter glass. A phosphate matrix is used and it is described that P⁵⁺ is a main component to form glass and is an essential component to improve the near infrared cutting performance.

US 2007/0099787 A1 describes aluminophosphate glasses containing copper(II) oxide having a low transmittance in the near infrared range.

U.S. Pat. No. 5,668,066 A describes a near infrared absorption filter glass having P₂O₅ as preferred glass network-forming component for increasing the transmittance at 400-600 nm and sharply changing the absorption by Cu²⁺ in a wavelength region greater than 700 nm.

U.S. Pat. No. 5,036,025 A describes a green optical filter phosphate-based glass having a strong near infrared absorption.

U.S. Pat. No. 5,242,868 A suggests using a fluorophosphate matrix for increasing the weather resistance of copper(II) oxide containing near infrared absorption filter glasses.

CN 105819685 A describes a copper(II) oxide containing infrared absorption cut-off filter glass based on a fluorophosphate matrix with improved chemical stability.

U.S. Pat. No. 5,173,212 A describes an aluminophosphate glass containing copper(II) oxide having a low transmittance in the near infrared range with a steep absorption edge.

U.S. Pat. No. 9,057,836 B2 describes a glass wafer made of a copper ions containing phosphate or fluorophosphate glass.

The glasses described previously do not have a high refractive index. However, DE 32 29 442 A1 discloses CuO containing phosphate glasses absorbing in the wavelength region between 600 and 800 nm and having a high refractive index. In order to achieve this, the glasses of DE 32 29 442 A1 contain large amounts of Sb₂O₃. Because of the high toxicity of Sb₂O₃, this kind of glass cannot be allowed in consumer electronics devices.

There is a need for glasses that have both a high refractive index (in particular a refractive index of at least 1.7) and at the same time good infrared absorption properties. Moreover, highly toxic components such as in particular Sb₂O₃, As₂O₃ and PbO should not be used in high amounts or better even are avoided for environmental and health reasons, especially for applications in consumer electronics. However, near infrared absorption filter glasses having a high refractive index have only been available based on such highly toxic components so far.

Glasses having a phosphate or fluorophosphate matrix as described in the prior art are not suitable to achieve highly refractive glasses because the refractive index of the glas matrix is too low. Thus, it would be advantageous if another glass matrix may be used. However, if copper(II) oxide was doped into another glass matrix, the transmission spectrum would change and may not be satisfactory.

What is needed in the art is a glass that has both a high refractive index (in particular a refractive index of at least 1.7) and at the same time good infrared absorption properties and that furthermore does not contain highly toxic components such as in particular Sb₂O₃, As₂O₃ and PbO in high amounts, as well as a method for producing such glass and uses of the glass.

### SUMMARY OF THE INVENTION

Some exemplary embodiments provided according to the present invention provide a CuO-containing glass having a refractive index n of at least 1.7, a minimum absorption coefficient in a visible wavelength range from 380 nm to 780 nm is located between 450 nm and 550 nm, a difference of the absorption coefficient normalized to CuO weight percent at a wavelength of 700 nm and the minimum absorption coefficient normalized to CuO weight percent in the visible wavelength range from 380 nm to 780 nm is at least 10/cm. The glass comprises the following components (in % by weight based on oxide): 0-70 wt-% La₂O₃, 0-70 wt-% Y₂O₃; 20-70 wt-% a sum of La₂O₃+Y₂O₃+RE₂O₃; 10-40 wt-% B₂O₃; 0-40 wt-% SiO₂; 0-10 wt-% Nb₂O₅; 0-30 wt-% ZnO; 0-20 wt-% ZrO₂; 0-20 wt-% Ta₂O₅; and 0.1-10 wt-% CuO. RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.

Some exemplary embodiments provided according to the present invention provide a method for producing a CuO-containing glass. The method includes: providing a composition; melting the composition to form a glass melt; and producing the glass from the glass melt. The glass has a refractive index n of at least 1.7, a minimum absorption coefficient in a visible wavelength range from 380 nm to 780 nm is located between 450 nm and 550 nm, a difference of the absorption coefficient normalized to CuO weight percent at a wavelength of 700 nm and the minimum absorption coefficient normalized to CuO weight percent in the visible wavelength range from 380 nm to 780 nm is at least 10/cm. The glass comprises the following components (in % by weight based on oxide): 0-70 wt-% La₂O₃; 0-70 wt-% Y₂O₃; 20-70 wt-% a sum of La₂O₃+Y₂O₃+RE₂O₃; 10-40 wt-% B₂O₃; 0-40 wt-% SiO₂; 0-10 wt-% Nb₂O₅; 0-30 wt-% ZnO; 0-20 wt-% ZrO₂; 0-20 wt-% Ta₂O₅; and 0.1-10 wt-% CuO. RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates transmission spectra of Examples 1 to 7 in a wavelength range from 400 to 1000 nm, with the transmittance T presented in % and shown on the y-axis and the wavelength is presented in nm and is shown on the x-axis; and

FIG. 2 illustrates absorption spectra of Examples 1 to 7 normalized to their CuO dopant concentration in the wavelength range from 400 to 1000 nm, the normalized absorption coefficient is presented in 1/cm/wt % and is shown on the y-axis and the wavelength is presented in nm and is shown on the x-axis.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Exemplary embodiments provided according to the present invention provide a CuO-containing glass having a refractive index n of at least 1.7. A minimum absorption coefficient in the visible wavelength range from 380 nm to 780 nm is located between 450 nm and 550 nm, such as between 480 nm and 530 nm, between 485 nm and 525 nm, or between 490 nm and 520 nm. A difference of an absorption coefficient normalized to CuO weight percent at a wavelength of 700 nm and the minimum absorption coefficient normalized to CuO weight percent in the visible wavelength range from 380 nm to 780 nm is at least 10/cm, such as at least 15/cm, at least 20/cm, at least 25/cm, at least 30/cm, or at least 32/cm. The glass comprises the following components, and in some embodiments consists essentially of the following components (in % by weight based on oxide):

| | Proportion (in % by weight based on |
|---|---|
| Component | oxide) |
| La₂O₃ | 0-70 |
| Y₂O₃ | 0-70 |
| Sum (La₂O₃ + Y₂O₃ + RE₂O₃) | 20-70 |
| B₂O₃ | 10-40 |
| SiO₂ | 0-40 |
| Nb₂O₅ | 0-10 |
| ZnO | 0-30 |
| ZrO₂ | 0-20 |
| Ta₂O₅ | 0-20 |
| CuO | 0.1-10 |

wherein RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.

The absorption coefficient (abs) may be determined according to the following formula:

abs(λ)=ln(1/□ᵢ(λ))/L (1)

wherein “ln” indicates the natural logarithm, “k” indicates the wavelength, “□ᵢ” indicates the internal transmittance and “L” indicates the thickness of the measured glass sample in unit centimeter (cm).

The internal transmittance is calculated from □ᵢ(λ)=T(λ)/P, wherein “T” indicates the measured transmittance from glass sample and “P” indicates the reflection factor, which is calculated by P=2n/(n²+1), wherein “n” indicates the refractive index of the sample glass. “n” slightly changes following wavelength. In the present specification, the refractive index at 532 nm is used for all discussion and calculation.

Thus, the absorption coefficient at a particular wavelength is easily determined based on the measured transmittance T of a glass sample at the particular wavelength, on the refractive index n at 532 nm and on the thickness L of the measured glass sample. The skilled person is able to determine the transmittance T, the refractive index n and the sample thickness L based on the common general knowledge.

In particular, the transmittance T is generally determined as the ratio I/L, wherein Io is the light intensity applied to the sample and I is the light intensity detected behind the sample. In other words, the measured transmittance T reflects the fraction of light of a particular wavelength that has been transmitted through the sample.

The refractive index n may be determined using a refractometer.

Transmission depends on glass thickness. Absorption coefficient depends on CuO dopant concentration. Only the absorption coefficient normalized to CuO doped weight percent correctly describes the glass matrix property the present invention focuses on and can be compared between different glass samples. Therefore, the present invention refers to the “absorption coefficient normalized to CuO weight percent”. The term “absorption coefficient normalized to CuO weight percent” indicates that the absorption coefficient determined as described previously is divided by the amount of CuO (in weight percent) in the glass. For example, if a glass has an absorption coefficient abs(λ) of 8/cm at a particular wavelength λ, and the glass contains CuO in an amount of 1 wt.-%, the absorption coefficient normalized to CuO weight percent is calculated as 8/cm divided by 1 wt.-% CuO and is thus 8/cm. For another glass having an an absorption coefficient abs(λ) of 8/cm but containing CuO in an amount of 4 wt.-%, the absorption coefficient normalized to CuO weight percent is calculated as 8/cm divided by 4 wt.-% CuO and is thus 2/cm.

The present invention also relates to a CuO-containing glass having a refractive index n of at least 1.7, with the minimum absorption coefficient in the visible wavelength range from 380 nm to 780 nm is located between 450 nm and 550 nm, such as between 480 nm and 530 nm, between 485 nm and 525 nm, or between 490 nm and 520 nm. The difference of the absorption coefficient normalized to CuO weight percent at a wavelength of 700 nm and the minimum absorption coefficient normalized to CuO weight percent in the visible wavelength range from 380 nm to 780 nm is at least 10/cm, such as at least 15/cm, at least 20/cm, at least 25/cm, at least 30/cm, or at least 32/cm. The glass comprises the following components, and in some embodiments consists essentially of the following components (in % by weight based on oxide):

| | Proportion (in % by weight based on |
|---|---|
| Component | oxide) |
| La₂O₃ | 20-70 |
| Y₂O₃ | 0-50 |
| Sum (La₂O₃ + Y₂O₃ + RE₂O₃) | 20-70 |
| B₂O₃ | 10-40 |
| SiO₂ | 1-10 |
| Nb₂O₅ | 1-10 |
| ZnO | 1-25 |
| ZrO₂ | 1-10 |
| Ta₂O₅ | 0-20 |
| CuO | 0.5-10 |

wherein RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.

The present invention also relates to a CuO-containing glass having a refractive index n of at least 1.7. The minimum absorption coefficient in the visible wavelength range from 380 nm to 780 nm is located between 450 nm and 550 nm, such as between 480 nm and 530 nm, between 485 nm and 525 nm, or between 490 nm and 520 nm. The difference of the absorption coefficient normalized to CuO weight percent at a wavelength of 700 nm and the minimum absorption coefficient normalized to CuO weight percent in the visible wavelength range from 380 nm to 780 nm is at least 10/cm, such as at least 15/cm, at least 20/cm, at least 25/cm, at least 30/cm, or at least 32/cm. The glass comprises the following components, and in some embodiments consists essentially of the following components (in % by weight based on oxide):

| | Proportion (in % by weight based on |
|---|---|
| Component | oxide) |
| La₂O₃ | 30-60 |
| Y₂O₃ | 0-10 |
| Sum (La₂O₃ + Y₂O₃) | 30-60 |
| B₂O₃ | 20-30 |
| SiO₂ | 1-5 |
| Nb₂O₅ | 1-5 |
| ZnO | 1-5 |
| ZrO₂ | 1-10 |
| Ta₂O₅ | 0-20 |
| CuO | 0.5-5 |

The glasses provided according to the present invention have a refractive index n of at least 1.70. In some embodiments, the glasses provided according to the present invention have a refractive index n of at least 1.71, such as at least 1.72, at least 1.73, at least 1.74, at least 1.75, more than 1.75, at least 1.76, at least 1.77, at least 1.78, at least 1.79, at least 1.80, more than 1.80, or at least 1.81. In some embodiments, the refractive index of the glasses provided according to the present invention is at most 2.00, such as at most 1.95 or at most 1.90. The term “refractive index” may indicate the refractive index n at a wavelength of 532 nm.

The minimum absorption coefficient of the glasses provided according to the present invention in the visible wavelength range from 380 nm to 780 nm is located between 450 nm and 550 nm, such as between 480 nm and 530 nm, between 485 nm and 525 nm, or between 490 nm and 520 nm.

The difference of the absorption coefficient normalized to CuO weight percent at a wavelength of 700 nm and the minimum absorption coefficient normalized to CuO weight percent in the visible wavelength range from 380 nm to 780 nm is at least 10/cm, such as at least 15/cm, at least 20/cm, at least 25/cm, at least 30/cm, or at least 32/cm.

In some embodiments, the absorption coefficient normalized to CuO weight percent at a wavelength of 700 nm is at least 25/cm, such as at least 30/cm or at least 35/cm.

The content of the sum of the rare earth oxides La₂O₃+Y₂O₃+RE₂O₃ in the glasses provided according to the present invention is from 20 to 70% by weight, such as from 25 to 68% by weight, from 30 to 66% by weight, from 35 to 64% by weight, from 40 to 62% by weight, or from 45 to 60% by weight. Such rare earth oxides in the indicated amounts are useful for achieving a glass matrix for obtaining CuO-containing glasses that have both a high refractive index and at the same time good infrared absorption properties. The term “RE₂O₃” includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof. Thus, the glasses provided according to the present invention comprise at least one component selected from the group consisting of La₂O₃, Y₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃. In some embodiments, the glasses provided according to the present invention comprise at most five, such as at most four, at most three, at most two, or at most one component selected from the group consisting of La₂O₃, Y₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃. In some embodiments, the glasses provided according to the present invention comprise La₂O₃, Y₂O₃ and additionally at most three, such as at most two, at most one, or no component selected from the group consisting of Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃. In some embodiments, the glasses provided according to the present invention comprise La₂O₃ and additionally at most four, such as at most three, at most two, at most one, or no component selected from the group consisting of Y₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃. In some embodiments, the glasses comprise Y₂O₃ and additionally at most four, such as at most three, at most two, at most one, or no component selected from the group consisting of La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃.

As described previously, the rare earth oxides of the glasses provided according to the present invention may be selected from the group consisting of La₂O₃, Y₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof. In some embodiments, the rare earth oxides of the glasses provided according to the present invention are selected from the group consisting of La₂O₃, Y₂O₃ and mixtures thereof. In some embodiments, La₂O₃ is the only rare earth oxide in the glasses provided according to the present invention.

The content of the sum of the rare earth oxides La₂O₃+Y₂O₃ in the glasses provided according to the present invention may be from 20 to 70% by weight, such as from 25 to 68% by weight, from 30 to 66% by weight, from 35 to 64% by weight, from 40 to 62% by weight, or from 45 to 60% by weight. Such rare earth oxides in the indicated amounts are useful for achieving a glass matrix for obtaining CuO-containing glasses that have both a high refractive index and at the same time good infrared absorption properties.

La₂O₃ is one exemplary rare earth oxide of the present invention. The content of La₂O₃ in the glasses provided according to the present invention is from 0 to 70% by weight, such as from 10 to 65% by weight, from 20 to 60% by weight, from 25 to 60% by weight, from 30 to 55% by weight, from 35 to 55% by weight, or from 40 to 50% by weight.

Y₂O₃ is another exemplary rare earth oxide of the present invention. The content of Y₂O₃ in the glasses provided according to the present invention is at most 70% by weight, such as at most 50% by weight, at most 40% by weight, at most 30% by weight, at most 20% by weight, or at most 10% by weight. The content of Y₂O₃ in the glasses provided according to the present invention should be limited because otherwise the refractive index may be compromised. The content of Y₂O₃ in the glasses provided according to the present invention may be at least 1% by weight, at least 2% by weight, or at least 5% by weight. In some embodiments, the glasses provided according to the present invention contain Y₂O₃ in an amount of at most 5% by weight, at most 2% by weight, at most 1% by weight or the glasses are even free of Y₂O₃.

Other exemplary rare earth oxides of the present invention may be selected from the group consisting of Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃. In some embodiments, the glasses provided according to the present invention contain rare earth oxides selected from the group consisting of Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof in an amount of at most 70% by weight, such as at most 30% by weight, at most 20% by weight, at most 10% by weight, at most 5% by weight, at most 2% by weight, at most 1% by weight or the glasses are even free of Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃. The amount of Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃ should be limited in order to reduce the risk of generating unwanted absorption in visible range.

B₂O₃ is an essential component of the glasses provided according to the present invention and is contained in an amount of from 10 to 40% by weight, such as 13 to 37% by weight, 17 to 34% by weight, or 20 to 30% by weight. B₂O₃ in the indicated amounts is useful for achieving a glass matrix for obtaining CuO-containing glasses that have both a high refractive index and at the same time good infrared absorption properties.

B₂O₃ and rare earth oxides (La₂O₃+Y₂O₃+RE₂O₃) are the main components of the glasses provided according to the present invention and may form a B₂O₃-rare earth oxide glass matrix. Such glass matrix was found to be useful for obtaining CuO-containing glasses that have both a high refractive index and at the same time good infrared absorption properties. In some embodiments, the content of B₂O₃+La₂O₃+Y₂O₃+RE₂O₃ in the glasses provided according to the present invention is from 50 to 97% by weight, such as from 60 to 95% by weight, from 70 to 90% by weight, or from 75 to 85% by weight. In some embodiments, the content of B₂O₃+La₂O₃+Y₂O₃ in the glasses provided according to the present invention is from 50 to 97% by weight, such as from 60 to 95% by weight, from 70 to 90% by weight, or from 75 to 85% by weight.

The glasses provided according to the present invention comprise SiO₂ in an amount of from 0 to 40% by weight, such as from 1 to 30% by weight, from 1 to 20% by weight, from 2 to 10% by weight, or from 3 to 5% by weight. High amounts of SiO₂ lower the refractive index and are therefore not preferable.

The glasses provided according to the present invention may comprise Li₂O. However, the content of Li₂O in the glasses is at most 20% by weight. In some embodiments, the content of Li₂O in the glasses provided according to the present invention is at most 15% by weight, such as at most 10% by weight, at most 8% by weight, at most 5% by weight, at most 2% by weight, at most 1% by weight or the glasses are even free of Li₂O. In some embodiments, the glasses provided according to the present invention comprise Li₂O in an amount of at least 1% by weight, such as at least 2% by weight.

The glasses provided according to the present invention may comprise Na₂O. However, the content of Na₂O in the glasses is at most 20% by weight. In some embodiments, the content of Na₂O in the glasses provided according to the present invention is at most 15% by weight, such as at most 10% by weight, at most 8% by weight, at most 5% by weight, at most 2% by weight, at most 1% by weight or the glasses are even free of Na₂O. In some embodiments, the glasses provided according to the present invention comprise Na₂O in an amount of at least 1% by weight, such as at least 2% by weight.

The glasses provided according to the present invention may comprise K₂O. However, the content of K₂O in the glasses is at most 20% by weight. In some embodiments, the content of K₂O in the glasses provided according to the present invention is at most 15% by weight, such as at most 10% by weight, at most 8% by weight, at most 5% by weight, at most 2% by weight, at most 1% by weight or the glasses are even free of K2O. In some embodiments, the glasses provided according to the present invention comprise K₂O in an amount of at least 1% by weight, such as at least 2% by weight.

The content of the sum of Li₂O+Na₂O+K₂O in the glasses provided according to the present invention is from 0 to 20% by weight, such as from 1 to 20% by weight, from 1 to 10% by weight, from 1.5 to 9% by weight, or from 2 to 8% by weight.

In some embodiments, the glasses provided according to the present invention comprise at least one alkali metal oxide selected from the group consisting of Li₂O, Na₂O and K₂O. In some embodiments, the glasses provided according to the present invention comprise exactly one alkali metal oxide selected from the group consisting of Li₂O, Na₂O and K₂O. In some embodiments, the glasses provided according to the present invention comprise Na₂O and at least one, such as exactly one alkali metal oxide selected from the group consisting of Li₂O and K₂O. In some embodiments, the glasses comprise Na2O but are free of Li₂O and K₂O.

The glasses provided according to the present invention may comprise MgO. However, the content of MgO in the glasses is at most 20% by weight. In some embodiments, the content of MgO in the glasses provided according to the present invention is at most 15% by weight, such as at most 10% by weight, at most 8% by weight, at most 5% by weight, at most 2% by weight, at most 1% by weight or the glasses are even free of MgO. In some embodiments, the glasses provided according to the present invention comprise MgO in an amount of at least 0.1% by weight, such as at least 0.5% by weight.

The glasses provided according to the present invention may comprise CaO. However, the content of CaO in the glasses is at most 20% by weight. In some embodiments, the content of CaO in the glasses provided according to the present invention is at most 15% by weight, such as at most 10% by weight, at most 8% by weight, at most 5% by weight, at most 2% by weight, at most 1% by weight or the glasses are even free of CaO. In some embodiments, the glasses provided according to the present invention comprise CaO in an amount of at least 0.1% by weight, such as at least 0.5% by weight.

The glasses provided according to the present invention may comprise SrO. However, the content of SrO in the glasses is at most 20% by weight. In some embodiments, the content of SrO in the glasses provided according to the present invention is at most 15% by weight, such as at most 10% by weight, at most 8% by weight, at most 5% by weight, at most 2% by weight, at most 1% by weight or the glasses are even free of SrO. In some embodiments, the glasses provided according to the present invention comprise SrO in an amount of at least 0.1% by weight, such as at least 0.5% by weight.

The glasses provided according to the present invention may comprise BaO. However, the content of BaO in the glasses is at most 20% by weight. In some embodiments, the content of BaO in the glasses provided according to the present invention is at most 15% by weight, such as at most 10% by weight, at most 8% by weight, at most 5% by weight, at most 2% by weight, at most 1% by weight or the glasses are even free of BaO. In some embodiments, the glasses provided according to the present invention comprise BaO in an amount of at least 0.1% by weight, such as at least 0.5% by weight.

The content of the sum of MgO+CaO+SrO+BaO in the glasses provided according to the present invention is from 0 to 20% by weight, such as from 0 to 10% by weight. In some embodiments, the content of the sum of MgO+CaO+SrO+BaO in the glasses provided according to the present invention is at most 8% by weight, such as at most 5% by weight, at most 2% by weight, at most 1% by weight or the glasses are even free of MgO, CaO, SrO and BaO. In some embodiments, the content of the sum of MgO+CaO+SrO+BaO in the glasses provided according to the present invention is at least 0.5% by weight, such as at least 1% by weight.

The content of Nb₂O₅ in the glasses provided according to the present invention is from 0 to 20% by weight, such as from 0 to 10% by weight. In some embodiments, the content of Nb₂O₅ is at most 15% by weight, such as at most 10% by weight or at most 5% by weight. In some embodiments, the glasses provided according to the present invention comprise Nb₂O₅ in an amount of at least 0.1% by weight, such as at least 0.5% by weight, or at least 1% by weight.

The glasses provided according to the present invention may comprise ZrO₂. ZrO₂ can increase the glass strength and durability. However, the content of ZrO₂ in the glasses is at most 20% by weight. In some embodiments, the content of ZrO₂ in the glasses provided according to the present invention is at most 15% by weight, such as at most 10% by weight. In some embodiments, the glasses provided according to the present invention comprise ZrO₂ in an amount of at least 0.1% by weight, such as at least 0.5% by weight or at least 1% by weight.

The glasses provided according to the present invention may comprise TiO₂. However, the content of TiO₂ in the glasses is at most 20% by weight. In some embodiments, the content of TiO₂ in the glasses provided according to the present invention is at most 15% by weight, such as at most 10% by weight, at most 8% by weight, at most 5% by weight, at most 2% by weight, at most 1% by weight or the glasses are even free of TiO₂. In some embodiments, the glasses provided according to the present invention comprise TiO₂ in an amount of at least 0.1% by weight, such as at least 0.5% by weight.

The glasses provided according to the present invention may comprise Ta₂O₅. Ta₂O₅ may be used for supporting an increased refractive index. However, Ta₂O₅ is a rather expensive component so that its content should be limited. The content of Ta₂O₅ in the glasses is at most 20% by weight. In some embodiments, the content of Ta₂O₅ in the glasses provided according to the present invention is at most 15% by weight, such as at most 10% by weight, at most 5% by weight, at most 2% by weight, at most 1% by weight or the glasses are even free of Ta₂O₅.

ZnO may be added into the glass to improve the chemical stability of this glass to water and acid. However, too much ZnO would change the transmission/block spectra of Cu(II) ions inside. Surprisingly, it was found that the transmission/block spectra of Cu(II) ions are only minimally changed if ZnO is used in combination with Ta₂O₅. The amount of Ta₂O₅ in % by weight may be at least half of the amount of ZnO in % by weight if comparably large amounts of ZnO, in particular more than 5% by weight of ZnO, are used. In other words, the ratio of the content of ZnO to the content of Ta₂O₅ in the glass may be at most 2 if comparably large amounts of ZnO, in particular more than 5% by weight of ZnO, are used. For example, the glasses provided according to the present invention may contain 30% by weight of ZnO plus 15% by weight of Ta₂O₅. Such high amounts of ZnO would change the transmission/block spectra of Cu(II) ions in absence of Ta₂O₅. However, if the amount of Ta₂O₅ is at least half the amount of ZnO, changes to the transmission/block spectra of Cu(II) ions are very small.

The content of ZnO in the glasses provided according to the present invention is from 0 to 30% by weight, such as from 0.1 to 20% by weight, from 0.5 to 10% by weight, or from 1 to 5% by weight. In embodiments in which the content of ZnO is more than 5% by weight, the ratio of the content of ZnO (in % by weight) to the content of Ta₂O₅ (in % by weight) in the glass may be at most 2, such as at most 1.5.

In some embodiments, the content of ZnO+Ta₂O₅ in the glasses provided according to the present invention is in the range of 0 to 45% by weight, such as 0.1 to 30% by weight, 0.5 to 15% by weight, or 1 to 5% by weight.

The glasses provided according to the present invention may comprise Al₂O₃. However, the content of Al₂O₃ in the glasses is at most 20% by weight. In some embodiments, the content of Al₂O₃ in the glasses provided according to the present invention is at most 15% by weight, such as at most 10% by weight, at most 8% by weight, at most 5% by weight, at most 2% by weight, at most 1% by weight or the glasses are even free of Al₂O₃. In some embodiments, the glasses provided according to the present invention comprise Al₂O₃ in an amount of at least 0.1% by weight, such as at least 0.5% by weight.

CuO is an essential component of the glasses provided according to the present invention. CuO serves for achieving the near infrared absorption properties of the glasses provided according to the present invention. CuO containing near infrared absorption filter glasses of the prior art are based on a phosphate or fluorophosphate matrix. In contrast, the glasses provided according to the present invention contain substantial amounts of B₂O₃ and rare earth oxides (La₂O₃+Y₂O₃+RE₂O₃) that may form a B₂O₃-rare earth oxide glass matrix. The glasses provided according to the present invention combine a high refractive index of at least 1.7 with excellent near infrared absorption properties. The content of CuO in the glasses provided according to the present invention is from 0.1 to 10% by weight, such as from 0.5 to 10% by weight, from 0.5 to 8% by weight, from 0.6 to 6% by weight, from 0.7 to 4% by weight, or from 0.8 to 2% by weight. CuO in the indicated amounts is useful for achieving the excellent near infrared absorption properties of the glasses provided according to the present invention. With too low CuO concentration, the absorption would be too low. Too high CuO concentration would increase the absorption too much so that very dark glasses would be obtained.

Highly toxic components, such as in particular Sb₂O₃, As₂O₃, Cd₂O₃ and PbO, should not be used in high amounts or better even are avoided for environmental and health reasons.

The content of Sb₂O₃ in the glasses provided according to the present invention may be at most 0.5% by weight, such as at most 0.2% by weight, at most 0.1% by weight, at most 0.05% by weight, or at most 0.02% by weight. In some embodiments, the glasses provided according to the present invention are free of Sb₂O₃.

The content of As₂O₃ in the glasses provided according to the present invention may be at most 0.5% by weight, such as at most 0.2% by weight, at most 0.1% by weight, at most 0.05% by weight, or at most 0.02% by weight. In some embodiments, the glasses provided according to the present invention are free of As₂O₃.

The content of Cd₂O₃ in the glasses provided according to the present invention may be at most 0.5% by weight, such as at most 0.2% by weight, at most 0.1% by weight, at most 0.05 % by weight, or at most 0.02% by weight. In some embodiments, the glasses provided according to the present invention are free of Cd₂O₃.

The content of PbO in the glasses provided according to the present invention may be at most 0.5% by weight, such as at most 0.2% by weight, at most 0.1% by weight, at most 0.05% by weight, or at most 0.02% by weight. In some embodiments, the glasses provided according to the present invention are free of PbO.

The content of the sum of Sb₂O₃+As₂O₃+Cd₂O₃+PbO in the glasses provided according to the present invention may be at most 0.5% by weight, such as at most 0.2% by weight, at most 0.1% by weight, at most 0.05% by weight, or at most 0.02% by weight. In some embodiments, the glasses provided according to the present invention are free of Sb₂O₃ and As₂O₃, free of Sb₂O₃ and PbO, free of Sb₂O₃ and Cd₂O₃ or free of any combination between Sb₂O₃, As₂O₃, Cd₂O₃ and PbO, in particular free of Sb₂O₃, As₂O₃, Cd₂O₃ and PbO.

The terms “X-free” and “free of component X,” respectively, as used herein, may refer to a glass, which essentially does not comprise said component X, i.e. such component may be present in the glass at most as an impurity or contamination, however, is not added to the glass composition as an individual component. This means that the component X is not added in essential amounts. Non-essential amounts according to the present invention are amounts of less than 100 ppm, such as less than 50 ppm and less than 10 ppm. In some embodiments, the glasses described herein essentially do not contain any components that are not mentioned in this description.

In some embodiments, a thickness of the glasses provided according to the present invention is in the range of from 0.05 mm to 1.2 mm, such as from 0.1 mm to 0.8 mm, from 0.15 mm to 0.7 mm, or from 0.175 mm to 0.675 mm.

In accordance with some exemplary embodiments provided according to the present invention, a method for producing a glass provided according to the present invention comprises the steps of
a) Providing a composition,
b) Melting the composition,
c) Producing a glass.

The glass composition that is provided according to step a) is a composition that is suitable for obtaining a glass provided according to the present invention.

The method may optionally comprise further steps.

The present invention also relates to the use of the glasses provided according to the present invention. In some embodiments, the glasses provided according to the present invention are used in light sensors, in particular in ambient light sensors, such as in the field of consumer electronics devices such as mobile phones.

### EXAMPLES

Example glasses were prepared and optical properties were determined. The glass compositions of representative examples of the present invention and selected optical properties are shown in Table 1 below. The glass compositions are shown in % by weight of an oxide basis.

TABLE 1

| | Example | Example | Example | Example | Example | Example | Example |
|---|---|---|---|---|---|---|---|
| | 1 | 2 | 3 | 4 | 5 | 6 | 7 |
| Thickness (mm) | 0.675 | 0.675 | 0.675 | 0.675 | 0.175 | 0.675 | 0.675 |
| n @ 532 nm | 1.80 | 1.84 | 1.81 | 1.79 | 1.80 | 1.76 | 1.92 |
| Reflection factor P | 0.85 | 0.84 | 0.85 | 0.85 | 0.85 | 0.86 | 0.82 |
| B₂O₃ | 25 | 22 | 20 | 24 | 24 | | |
| BaO | | | | | | 8 | 20 |
| CuO | 1 | 1 | 1 | 1 | 4 | 1 | 1 |
| K₂O | | | | | | 6 | 4 |
| La₂O₃ | 47 | 40 | 28 | 38 | 47 | | |
| Na₂O | | | | | | 12 | |
| Nb₂O₅ | 3 | 4 | 6 | 6 | 3 | 10 | 48 |
| P₂O₅ | | | | | | | 22 |
| SiO₂ | 3 | 2 | 4 | 4 | 3 | 33 | |
| Ta₂O₅ | | 6 | 15 | 1 | | | |
| TiO₂ | | | | | | 30 | 5 |
| Y₂O₃ | 10 | | 2 | 2 | 9 | | |
| ZnO | 4 | 4 | 20 | 20 | 3 | | |
| ZrO₂ | 7 | 7 | 4 | 4 | 7 | | |
| Gd₂O₃ | | 14 | | | | | |
| La₂O₃ + Y₂O₃ + RE₂O₃ | 57 | 54 | 30 | 40 | 56 | 0 | 0 |
| La₂O₃ + Y₂O₃ + RE₂O₃ + B₂O₃ | 82 | 76 | 50 | 64 | 80 | 0 | 0 |
| abs(min)/CuO(wt %) | 3.63 | 5.95 | 4.20 | 4.53 | 10.50 | 6.85 | 22.21 |
| abs(min) at (nm) | 500 | 516 | 508 | 526 | 522 | 546 | 730 |
| abs(700 nm)/CuO(wt %) | 37.12 | 36.46 | 37.61 | 23.13 | 41.41 | 21.24 | 22.80 |
| (abs(700 nm) − | 33.48 | 30.51 | 33.41 | 18.59 | 30.91 | 14.39 | 0.59 |
| abs(min))/CuO(wt %) | | | | | | | |

In Table 1, “n” indicates the refractive index at 532 nm, “abs(700 nm)/CuO(wt %)” indicates absorption coefficient normalized to CuO weight percent at a wavelength of 700 nm, “abs(min)/CuO(wt %)” indicates the minimum absorption coefficient normalized to CuO weight percent in the visible wavelength range from 380 nm to 780 nm, “abs(min) at” indicates the wavelength corresponding to the minimum absorption coefficient and “(abs(700 nm)-abs(min))/CuO(wt %)” indicates the difference of the absorption coefficient normalized to CuO weight percent at a wavelength of 700 nm and the minimum absorption coefficient normalized to CuO weight percent in the visible wavelength range from 380 nm to 780 nm.

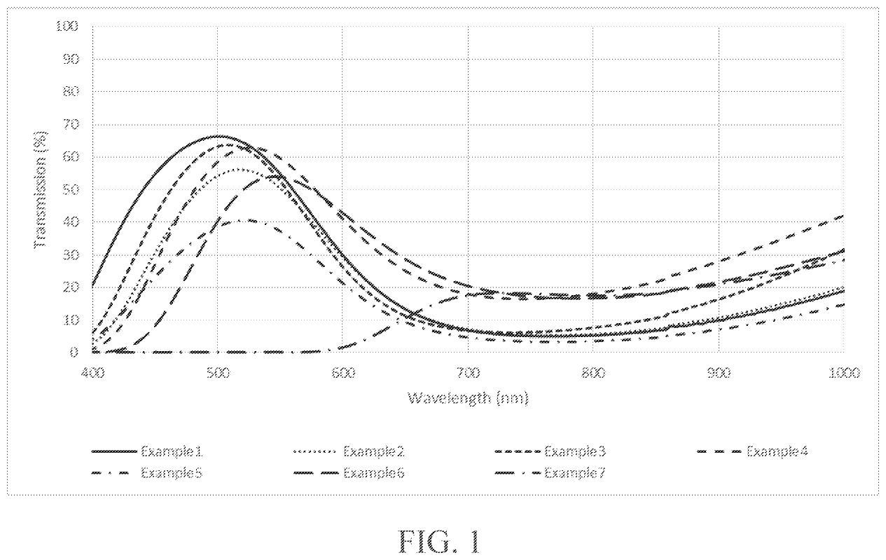

The transmittance T of Examples 1 to 7 in the wavelength range from 400 to 1000 nm is shown in FIG. 1.

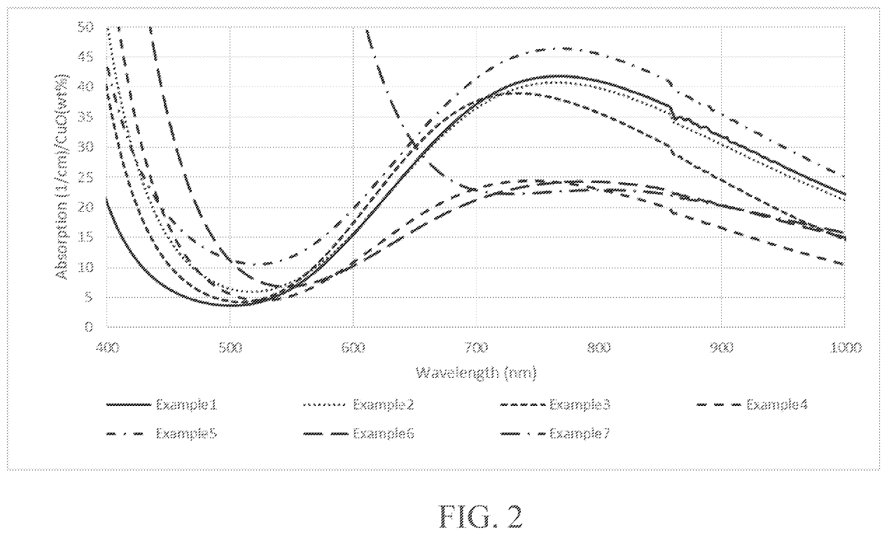

The absorption coefficient normalized to CuO weight percent of Examples 1 to 7 in the wavelength range from 400 to 1000 nm is shown in FIG. 2.

The absorption coefficient normalized to CuO weight percent as shown in FIG. 2 is calculated based upon the transmittance values shown in FIG. 1, as described previously. For example, the glass of Example 1 has a transmittance T of about 0.6635 at a wavelength of 500 nm. The reflection factor calculated as P=2n/(n²+1) is about 0.85. Hence, the internal transmittance □ᵢ(500 nm)=T(500 nm)/P is about 0.6635/0.85=0.78. The thickness L of the glass is 0.0675 cm. Thus, the absorption coefficient abs(500 nm)=ln(1/□ᵢ(500 nm))/L is equal to ln(1/0.78) divided by 0.0675 cm, which is about 3.63/cm. The normalization to CuO weight percent is done by dividing the absorption coefficient of 3.63/cm by the amount of CuO (in weight percent) in the glass. The glass of Example 1 comprises 1 wt.-% of CuO. Thus, the absorption coefficient normalized to CuO weight percent is 3.63/cm. Calculation was done accordingly for the other wavelengths and other glasses in order to obtain the absorption coefficient normalized to CuO weight percent as shown in FIG. 2 based upon the transmittance values shown in FIG. 1. Notably, the glass of Example 5 comprises CuO in an amount of 4 wt.-%. Thus, the absorption coefficient normalized to CuO weight percent was calculated by dividing the absorption coefficient obtained according abs(500 nm)=ln(1/□ᵢ(500 nm))/L by the value of 4.

Example 1 is a typical example provided according to the present invention. Its main glass matrix is composed by 25% by weight of B₂O₃, 47% by weight of La₂O₃ and 10% by weight of Y₂O₃. The glass has a refractive index of 1.8. When doped with 1% by weight of CuO, as shown in FIG. 1, Example 1 has a broad high transmission band in visible range between 400-600 nm and a low transmission band in near infrared range between 700-1000 nm. These optical properties show that the glass is a “blue glass with high refractive index”.

Example 2 shows the result to replace some La₂O₃ and Y₂O₃ to other rare earth ions, here with 14% by weight of Gd₂O₃. With 1% by weight of CuO, the transmission spectrum of Example 2 is similar to that of Example 1. Just Example 2 has some extent lower transmission at visible range.

Example 3 is another surprising result. It was found significant amount of rare earth elements could be replaced by ZnO+Ta₂O₅, without changing the transmission too much. Especially, if there was not Ta₂O₅, the same amount ZnO could cause obvious change at transmission.

That is what Example 4 shows. However, even Example 4 still fulfills the requirements on optical properties according to the present invention. Thus, it is advantageous but not necessary to add Ta2O5 along with ZnO even if comparably high amounts of ZnO are used. Comparing with Example 1, the transmission spectrum of Example 3 has lower transmission at visible range and higher transmission at NIR range. But, since ZnO is much cheaper than La₂O₃, Example 3 is still attractive in view of economic reasons.

The composition of Example 5 is very similar to Example 1, but doped with 4% by weight of CuO. In transmission spectra as FIG. 1, these two glasses are hard to compare. If Example 5 was prepared the same thickness as the other samples, Example 5 would become so dark that no measurable transmission could be shown in FIG. 1. While, in absorption coefficient normalized to CuO dopant concentration as FIG. 2, Example 5 correctly shows very close curve to Examples 1-3, representing the similar glass matrix feature to Cu(II) ions absorption contained in it.

Example 6 is a typical high refractive index glass composition but is different as what is claimed according to the present invention. The main glass matrix of Example 6 is composed of 33% by weight of SiO₂, 30% by weight of TiO₂, 10% by weight of Nb₂O₅ and 8% by weight of BaO. To decrease the melting temperature, some raw materials for Na and K ions is added. It can be seen that the minimum absorption wavelength is at 546 nm, much longer than Example 1-3. While the absorption at infrared range (700-1000 nm) is obviously lower than Example 1-3. Such a transmission/absorption spectrum has deviated the usual “blue glass” aiming for IR cut filter and for ambient light sensor applications.

Example 7 is another high refractive index glass composition being different from the composition of the glasses provided according to the present invention. Thus, Example 7 is a comparative example. The main glass matrix of Example 7 is composed of 48% by weight of Nb₂O₅, 20% by weight of BaO and, especially, 22% by weight of P₂O₅. P₂O₅ is thought to have benefit for Cu(II) absorption because current successful blue glass all are phosphate for fluorophosphate matrixes. However, when doped with 1% by weight of CuO, the transmission of Example 7 became so strange that it is totally no use to IR cut filter and ambient light sensor applications.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A CuO-containing glass having a refractive index n of at least 1.7, a minimum absorption coefficient in a visible wavelength range from 380 nm to 780 nm is located between 450 nm and 550 nm, a difference of the absorption coefficient normalized to CuO weight percent at a wavelength of 700 nm and the minimum absorption coefficient normalized to CuO weight percent in the visible wavelength range from 380 nm to 780 nm is at least 10/cm, the glass comprising the following components (in % by weight based on oxide):

| | Proportion (in % by weight based on |
|---|---|
| Component | oxide) |
| La₂O₃ | 0-70 |
| Y₂O₃ | 0-70 |
| Sum (La₂O₃ + Y₂O₃ + RE₂O₃) | 20-70 |
| B₂O₃ | 10-40 |
| SiO₂ | 0-40 |
| Nb₂O₅ | 0-10 |
| ZnO | 0-30 |
| ZrO₂ | 0-20 |
| Ta₂O₅ | 0-20 |
| CuO | 0.1-10 |

wherein RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.

2. The glass of claim 1, wherein the glass comprises the following components (in % by weight based on oxide):

| | Proportion (in % by weight based |
|---|---|
| Component | on oxide) |
| La₂O₃ | 20-70 |
| Y₂O₃ | 0-50 |
| Sum (La₂O₃ + Y₂O₃ + RE₂O₃) | 20-70 |
| B₂O₃ | 10-40 |
| SiO₂ | 1-10 |
| Nb₂O₅ | 1-10 |
| ZnO | 1-25 |
| ZrO₂ | 1-10 |
| Ta₂O₅ | 0-20 |
| CuO | 0.5-10 |

wherein RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.

3. The glass of claim 1, wherein the glass comprises the following components (in % by weight based on oxide):

| | Proportion (in % by weight based on |
|---|---|
| Component | oxide) |
| La₂O₃ | 30-60 |
| Y₂O₃ | 0-10 |
| Sum (La₂O₃ + Y₂O₃) | 30-60 |
| B₂O₃ | 20-30 |
| SiO₂ | 1-5 |
| Nb₂O₅ | 1-5 |
| ZnO | 1-5 |
| ZrO₂ | 1-10 |
| Ta₂O₅ | 0-20 |
| CuO | 0.5-5 |

4. The glass of claim 1, wherein the glass has a refractive index n of at least 1.71, the minimum absorption coefficient normalized to CuO weight percent in the visible wavelength range from 380 nm to 780 nm is located between 480 nm and 530 nm and the difference of the absorption coefficient normalized to CuO weight percent at a wavelength of 700 nm and the minimum absorption coefficient normalized to CuO weight percent in the visible wavelength range from 380 nm to 780 nm is at least 15/cm.

5. The glass of claim 1, wherein the glass comprises La₂O₃ in an amount of from 30 to 55% by weight, wherein a content of the sum of La₂O₃+Y₂O₃ is from 45 to 60% by weight.

6. The glass of claim 1, wherein the glass contains rare earth oxides selected from the group consisting of Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof in an amount of at most 30% by weight.

7. The glass of claim 1, wherein a content of a sum of B₂O₃+La₂O₃+Y₂O₃+RE₂O₃ in the glass is at least 50% by weight.

8. The glass of claim 1, wherein the content of Ta₂O₅ is from 0 to 10% by weight.

9. The glass of claim 1, wherein the content of ZnO in the glass is more than 5% by weight and a ratio of the content of ZnO (in % by weight) to the content of Ta₂O₅ (in % by weight) in the glass is at most 2.

10. The glass of claim 1, wherein the content of CuO is from 0.6 to 6% by weight.

11. The glass of claim 10, wherein the content of CuO is from 0.7 to 4% by weight.

12. The glass of claim 1, wherein a content of Sb2O3 in the glass is at most 0.5% by weight.

13. The glass of claim 1, wherein a content of As2O3 in the glass is at most 0.5% by weight.

14. The glass of claim 1, wherein a content of PbO in the glass is at most 0.5% by weight.

15. The glass of claim 1, wherein a content of a sum of Sb₂O₃+As₂O₃+PbO in the glass is at most 0.5% by weight.

16. The glass of claim 1, wherein the glass has a refractive index n>1.75.

17. The glass of claim 16, wherein the glass has a refractive index n>1.8.

18. The glass of claim 1, wherein the minimum absorption coefficient normalized to CuO weight percent in the visible wavelength range from 380 nm to 780 nm is located between 490 nm and 520 nm.

19. The glass of claim 1, wherein the difference of the absorption coefficient normalized to CuO weight percent at a wavelength of 700 nm and the minimum absorption coefficient normalized to CuO weight percent in the visible wavelength range from 380 nm to 780 nm is >20/cm.

20. The glass of claim 19, wherein the difference of the absorption coefficient normalized to CuO weight percent at a wavelength of 700 nm and the minimum absorption coefficient normalized to CuO weight percent in the visible wavelength range from 380 nm to 780 nm is >25/cm.

21. The glass of claim 20, wherein the difference of the absorption coefficient normalized to CuO weight percent at a wavelength of 700 nm and the minimum absorption coefficient normalized to CuO weight percent in the visible wavelength range from 380 nm to 780 nm is >30/cm.

22. A method for producing a CuO-containing glass, the method comprising:
providing a composition;
melting the composition to form a glass melt; and
producing the glass from the glass melt, the glass having a refractive index n of at least 1.7, a minimum absorption coefficient in a visible wavelength range from 380 nm to 780 nm is located between 450 nm and 550 nm, a difference of the absorption coefficient normalized to CuO weight percent at a wavelength of 700 nm and the minimum absorption coefficient normalized to CuO weight percent in the visible wavelength range from 380 nm to 780 nm is at least 10/cm, the glass comprising the following components (in % by weight based on oxide):

| | Proportion (in % by weight based on |
|---|---|
| Component | oxide) |
| La₂O₃ | 0-70 |
| Y₂O₃ | 0-70 |
| Sum (La₂O₃ + Y₂O₃ + RE₂O₃) | 20-70 |
| B₂O₃ | 10-40 |
| SiO₂ | 0-40 |
| Nb₂O₅ | 0-10 |
| ZnO | 0-30 |
| ZrO₂ | 0-20 |
| Ta₂O₅ | 0-20 |
| CuO | 0.1-10; |

wherein RE₂O₃ includes Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃ and mixtures of two or more thereof.
